(19) United States
(12) Patent Application Publication
(10) Pub. No.: US 2014/0227893 A1
(43) Pub. Date: Aug. 14, 2014

(54) POWER-SUPPLY DEVICE THAT PROVIDES POWER TO A SHELVING SYSTEM

(71) Applicant: L & P PROPERTY MANAGEMENT COMPANY, SOUTH GATE, CA (US)

(72) Inventor: JOHN DALE HOWARD, TEMPLE, GA (US)

(73) Assignee: L & P PROPERTY MANAGEMENT COMPANY, SOUTH GATE, CA (US)

(21) Appl. No.: 13/767,542

(22) Filed: Feb. 14, 2013

(51) Int. Cl. H01R 25/14; H01R 43/26

(52) U.S. Cl. CPC H01R 25/14; H01R 43/26
USPC 439/121; 29/825; 29/876

(57) ABSTRACT

A power-supply device that is retrofitted to a shelving system and that provides power to the shelving system having a mounting component that receives an article supporting structure comprises, a power-transmitting rail having a power-conducting element encased in a protective cover. The power-transmitting rail is attachable to the shelving system adjacent to the mounting component. The power-receiving component has a power-receiving element adapted to engage the power-conducting element. The power-receiving component is attached to the article-supporting structure, and the article-supporting structure when attached to the shelving system at the mounting component aligns the power-receiving element to contact the power-conducting element.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present invention generally relates to providing power to a shelving system. In one embodiment, a power-supply device is attachable to the shelving system which includes a base structure. The shelving system has a mounting component that receives an article-supporting structure at various positions along a first orientation. The power-supply device comprises a power-transmitting rail having a power-conducting element encased in a protective cover. The power-transmitting rail is attachable to the shelving system in a second orientation substantially similar to the first orientation. The power-transmitting rail may also be attached adjacent to the mounting component. The power-supply device also comprises a power-receiving component having a power-receiving element adapted to engage the power-conducting element. The power-receiving component is attachable to the article-supporting structure. The article-supporting structure aligns the power-receiving element to contact the power-conducting element when the article-supporting structure is attached to the mounting component of the shelving system.

In another embodiment, a power-supply device that is attachable to a shelving system to retrofit and provide power to the shelving system is disclosed. The shelving system includes a back panel supporting and an upright mounting component that receives a shelf. The power-supply device comprises a power-transmitting rail having a power-conducting element encased in a protective cover. The power-transmitting rail is attachable to the back panel adjacent to the upright mounting component that receives the shelf. The power-supply device also includes a power-receiving component having a power-receiving element adapted to engage the power-conducting element. The power-receiving component is attachable to the shelf, and the shelf aligns the power-receiving element to contact the power-conducting element when the shelf is attached to the upright mounting component of the shelving system.

In another embodiment, a method for retrofitting, and providing power to, a shelving system which includes a base structure. The shelving system has a mounting component that receives an article-supporting structure. The method comprises attaching a power-transmitting rail having a power-conducting element encased in a protective cover to the shelving system. The power-transmitting rail is positioned adjacent to the mounting component. The method also includes mounting the article-supporting structure to the mounting component to cause alignment and contact between a power-receiving element of a power-receiving component and the power-conducting element. The power-receiving component is attachable to the article-supporting structure.

Additional objects, advantages, and novel features of the invention are set forth in the description which follows and will become apparent to those ordinarily skilled in the art upon examination of the following, or may be learned by practice of the invention.

### BRIEF DESCRIPTION OF THE SEVERAL VIEWS OF THE DRAWINGS

Illustrative embodiments of the present invention are described in detail below with reference to the attached drawing figures, which are incorporated herein by reference, wherein:

FIG. 1 depicts an isometric view of a shelving system;

FIG. 2 depicts an exploded view of a power-supply device in accordance with an embodiment of the present invention;

FIGS. 3A and 3B depict a bottom view of a power-receiving component and a power-transmitting component in accordance with an embodiment of the present invention;

FIG. 4 depicts a top view of a power-receiving component and a power-transmitting component in accordance with an embodiment of the present invention;

FIG. 5 depicts a side view of a power-receiving component and a power-transmitting component in accordance with an embodiment of the present invention;

FIG. 6A depicts an isometric view of a power-conducting assembly in accordance with an embodiment of the present invention;

FIG. 6B depicts an isometric view of an article-support structure in accordance with an embodiment of the present invention; and

FIG. 7 depicts a flow diagram including steps of a method that is carried out in accordance with an embodiment of the present invention.

### DETAILED DESCRIPTION OF THE INVENTION

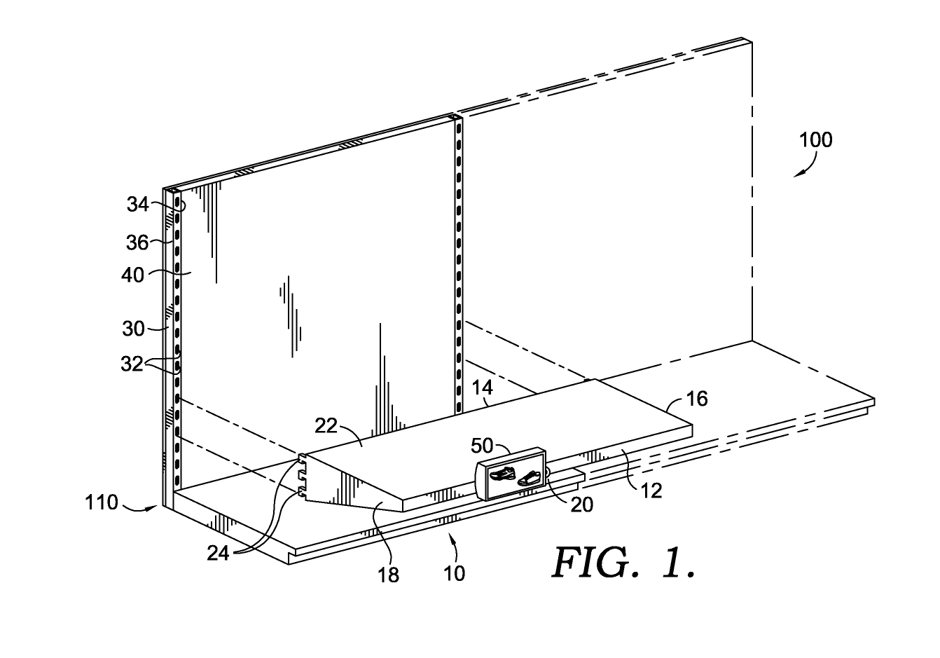

Referring to FIG. 1, a shelving system 100 is shown and will be described for background and general context. The shelving system 100 (e.g., gondola shelving, back-mounted shelving, peg-mounted shelving) vary in load capacity and aesthetics. Many types of shelving systems are available commercially. The common elements of these systems include vertical support members, horizontal support members, connecting elements that connect the support members and shelving elements. The shelving systems might also be configured to be easily assembled or dismantled. Garage and utility shelving is often made of lumber and plywood. Household shelving is made using metal brackets and braces and is adjustable. There also are different types of shelf hangers. Some hangers are metal clips that attach to metal runners, while others are plastic pegs that fit into holes in the sides of the shelf structure. Shelving system 100 is merely one example given for context and background and many other forms of shelving systems might be used in accordance with the invention.

Shelving system 100 includes a base structure 110. The base structure is the bottom support for the shelving system 100. The base structure 110 might enable the shelving system 100 to sustain pressure applied to it, such as, pressure from an article-supporting structure 10 (hereinafter “shelf”) mounted onto the shelving system 100 and the items held by the article-supporting structure 10. A shelf 10 is used to store and display a variety of products. The shelf 10 is also be used to deliver power to an electronic device 50 that receives power from the shelf 10. The shelf 10 comprises a front portion 12, a back portion 14, a first-side 16, and a second-side 18, a bottom surface 20, and a top surface 22. The first-side 16 and the second-side 18 of shelf 10 might each be mirror images of the other and detachably mounted and attached via brackets 24 at each side. Each bracket might define fasteners (e.g. hooks) at the rear end of the brackets 24 for engaging support members 30 (hereinafter “uprights”) at mounting components 32 (hereinafter “slot”). The shelf 10 might be mounted at various positions along a first orientation of the uprights 30. For example, the shelving system 100 might have uprights along a vertical orientation or a horizontal orientation on the shelving system 100 for supporting the shelf 10. The shelving system might also have uprights 30 with slots 32 that receive the shelf 10 via brackets 24 in a first orientation. Each upright 30 might include an inner edge 34 and an outer edge 36 on either side of the slot 32. In embodiments, an upright 30 includes a plurality of slots 32 spaced at regular intervals along a line extending lengthwise of the upright 30. Further, the shelving system 100 might also include a back panel 40 for supporting the uprights 30. The back panel 40 is vertically oriented extending from one upright member to the other. It should be understood that this and other arrangements described herein are set forth only as examples. Other arrangements and components might be used in addition to or instead of those shown, and some elements might be omitted altogether.

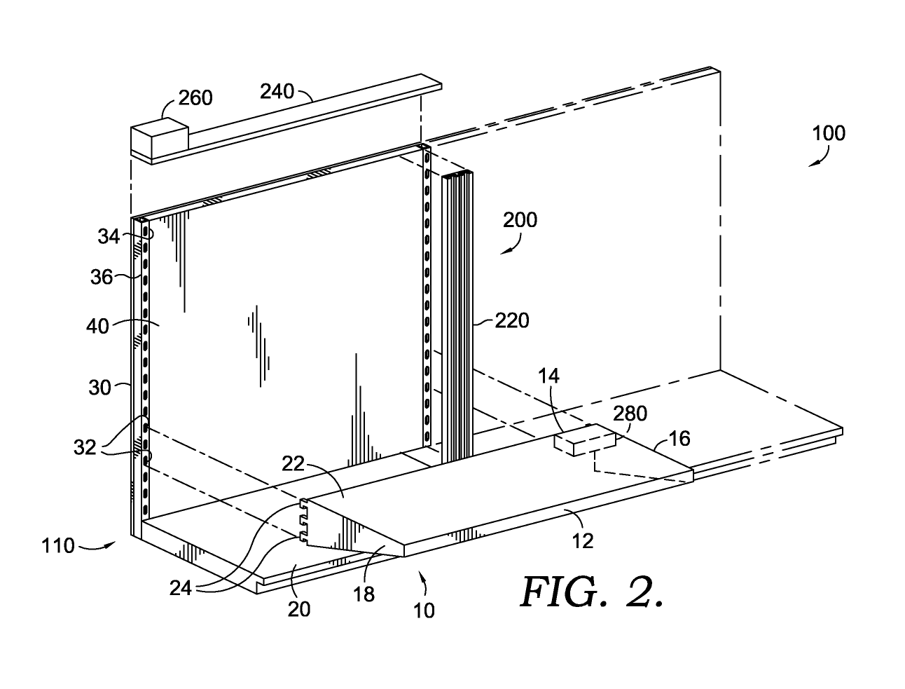

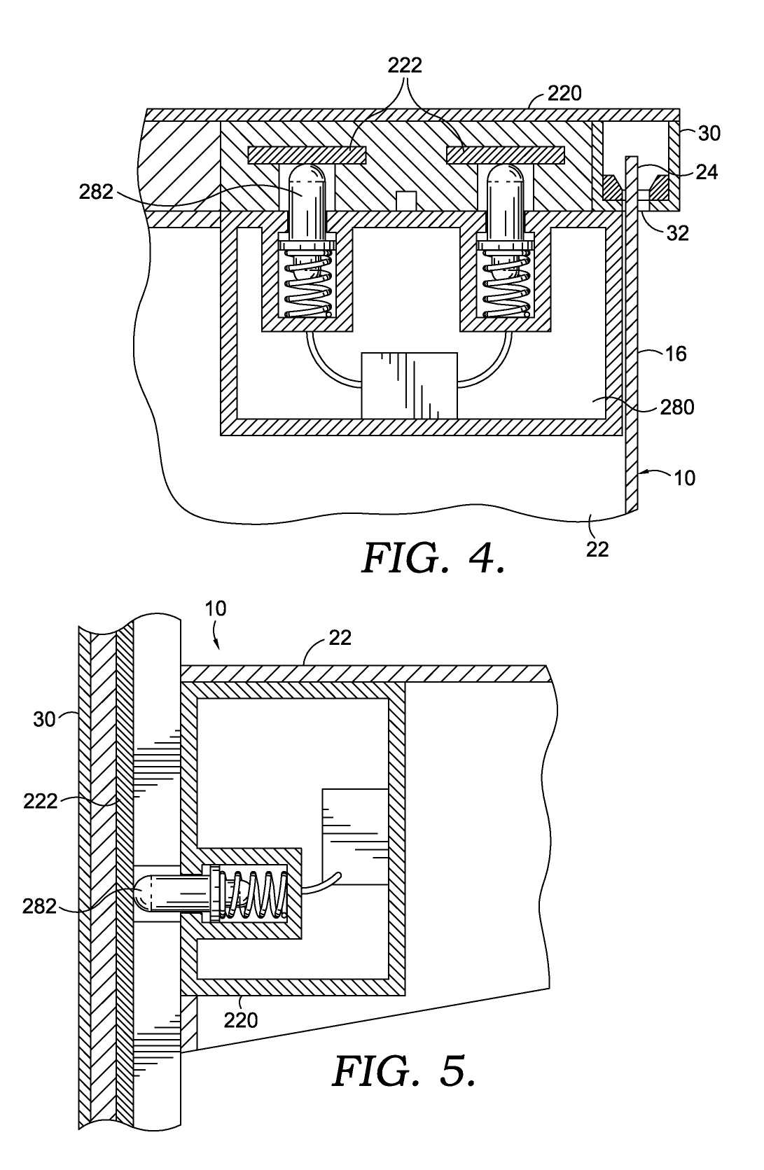

Embodiments of a power-supply device 200 according to the invention are shown in FIGS. 2-5. As shown in FIG. 2, power-supply device 200 is attachable onto an existing shelving system 100 to provide power to the shelving system 100. The power-supply device 200 comprises the following components: a power-transmitting rail 220, a power-source rail 240, a power converter 260, and a power-receiving component 280. The power-supply device 200 provides power to the shelving system 100 via the power transmitting rail 220 that includes one or more conductive rails (e.g., electrical busses or bus-bars) (collectively hereinafter “power-conducting element”). For example, as shown in FIGS. 4-5, the power-transmitting rail 220 supplies power via the power-conducting element 222 made of copper, brass, aluminum or other suitable material that conducts electricity within the power-transmitting rail 220.

Typically the power-transmitting rail 220 includes one or more voltage, neutral, and grounding power-conducting elements 222 or other suitable configurations. The power-transmitting rail 220 might comprise a hollow elongated extrusion made of a suitable protective cover (e.g., plastic). For example, the power-conducting element 222 might be encased in a protective cover fabricated from an electricity insulating material so as to prevent an electrical short in the power conducting element. In addition, channels might be formed on the interior of the hollow power-transmitting rails 220 within which an extruded plastic carrier holds the power-conducting element 222. The power-conducting element 222 conducts electricity throughout the power-conducting element 222 extending along the length of the power-transmitting rails 220. The power-conducting element 222 is fabricated from a conductive material and it is contemplated that even though protective covering is employed, electrical transmission via the power-conducting element 222 is still provided. For example, the power-transmitting rail 220 might include one or more power lines that are used to transmit power to the shelf 10 when attached in a vertical orientation to the shelving system 100.

As shown in FIG. 2, the power-transmitting rail 220 is attachable to the shelving system 100 adjacent to the uprights 30. The power-transmitting rail 220 is attached to the shelving system 100 in several different orientations. It is contemplated that the power-transmitting rail 220 might be attached to the shelving system 100 in an orientation substantially similar to that of the uprights 30. For example, the power-transmitting rail 220 is be adapted for snap-in engagement in the position side-by-side to the upright 30 such that the power-transmitting rail 220 is placed along an inner edge 34 of the uprights 30. Snap-in engagement is used to provide ease of installation and operation. It is contemplated in accordance with embodiments of the present invention that additional methods may be used for attaching the power-transmitting rail 220 to the shelving system. Other attachment methods may include but not limited to double-sided tape, screws, clamps and other apparatus that hold or secure the power-transmitting rail 220 tightly to the shelving system 100 to prevent movement.

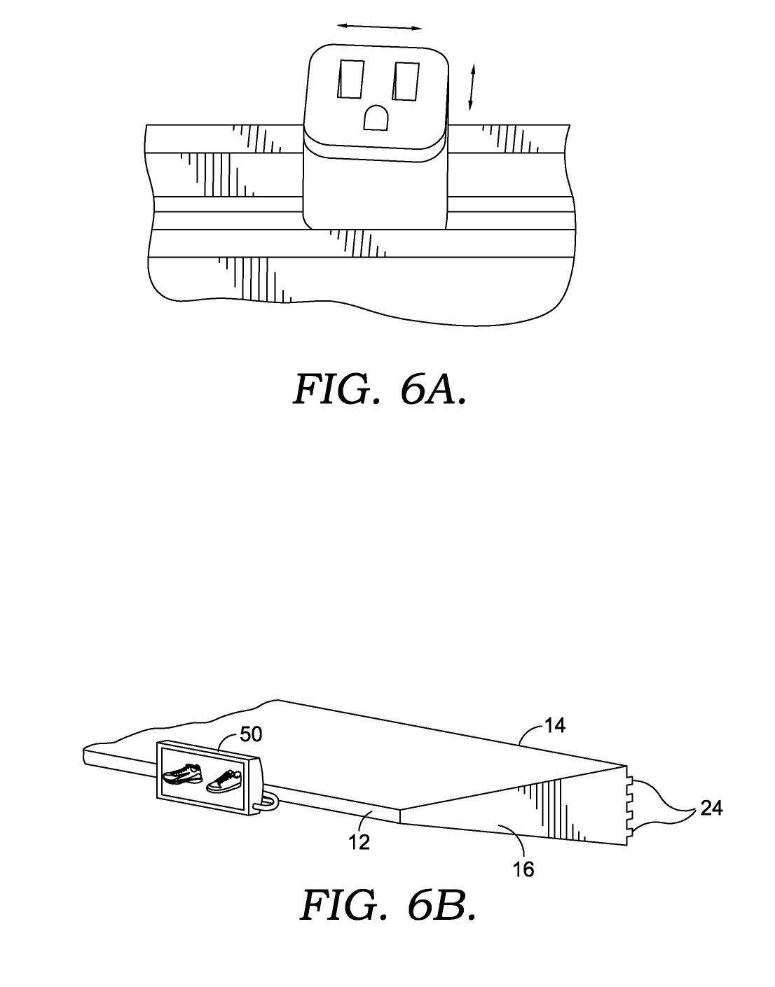

In one embodiment, the power-transmitting rail 220 might be coupled to a power-conducting assembly 230 (e.g., power adapter or power connector) as shown in FIG. 6A that is mounted onto the power-transmitting rail 220 to conduct power. The power-conducting assembly 230 is made of electricity insulating material and houses an electrical contact. A power-conducting assembly 230 might used to transmit power from a power source (e.g., power-source rail 240) to the power-transmitting rail 220 but might also be used to transmit power from the power-transmitting rail 220 to the shelf 10. For example, the power-conducting assembly 230 is received at the end of the power-transmitting rail 220 and coupled to a power source and the electrical contacts within the power-conducting assembly 230 transmit power from the power source to the power-transmitting rail 220. Alternatively, when the power-conducting assembly 230 is mounted onto the power-transmitting rail 220 the electrical contact in the power-conducting assembly 230 contacts the power-conducting element 222 of the power-transmitting rail 220 and provides power to the shelf 10. It is contemplated in accordance with embodiments of the present invention that additional different types of power adapters may be used as a power-conducting. In one embodiment, the power conducting assembly may be an outlet adapter as shown in FIG. 6A. An outlet adapter may be used, for example, with the power-source 260 rail to receive power from the power converter 260.

With continued reference to FIG. 2, the power-supply device 200 also includes a horizontal support member or power-source rail 240 of the shelving system 100. The power-source rail 240 might extend horizontally across the shelving system 100. The power-source rail 240 might be metallic or other similarly strong material that supports the shelving system 100. In embodiments, the power-source rail 240 is similar in structure and configuration to the power-transmitting rail 220. In one embodiment, the power-transmitting rail 220 is configured to couple to the power-source rail 240 to receive power from the power-source rail 240. As used herein, coupling refers to electrical coupling that is the transfer of power from one medium, such as a metallic wire to another. For example, energy is transferred from a power source to an electrical load by means of conductive coupling, which might be either resistive or hard-wire. Electrical coupling between different components in the present invention contemplates the use of methods as understood in the art. As such, the power-transmitting rail 220 might be electrically coupled to the power-source rail 240. For example, the power-source rail 240 might include electrical conductors that allow the power-transmitting rail 220 to receive power from the electrical conductors in the power-source rail 240. As discussed earlier, the power-source rail 240 and the power transmitting rail 220 might be coupled by way of the power-conducting assembly 230. For example, a power-conducting assembly 230 (e.g., power port) is coupled to the power-source rail 240 to allow the power-transmitting rail 220 to be coupled to the power-source rail 240. Alternatively, the power-source rail 240 transmits power to the power-transmitting rail 220 through the electrical contact of electrical conductors in each rail. It is contemplated that the power-source rail 240 transmits power to the power-transmitting rail 220 in other ways understood in the art.

With continued reference to FIG. 2, the power-source rail 240 is be coupled to a power converter 260 (e.g., transformer) configured to convert high voltage power level such as 120V AC into low voltage level DC or AC power such as 12V DC or AC power. The power converter 260 might be physically attached to the shelving system 100. For example, the power converter 260 might be positioned adjacent the power-source rail 240 for access proximity and direct power supply to the rail. In embodiments, the power converter 260 is attached to the power-source rail 240 such that it transmits power to the power-source rail 240. In operation, the power converter 260 works like a transformer, as understood in the art, for use in conversion of power. Instead of using 120V AC power, for safety purposes, the power converter 260, might be configured to transform the power to a lower power. For example, 12V DC is be delivered along the power rails of the power-source rail 240 for supplying power to the power-transmitting rails 220.

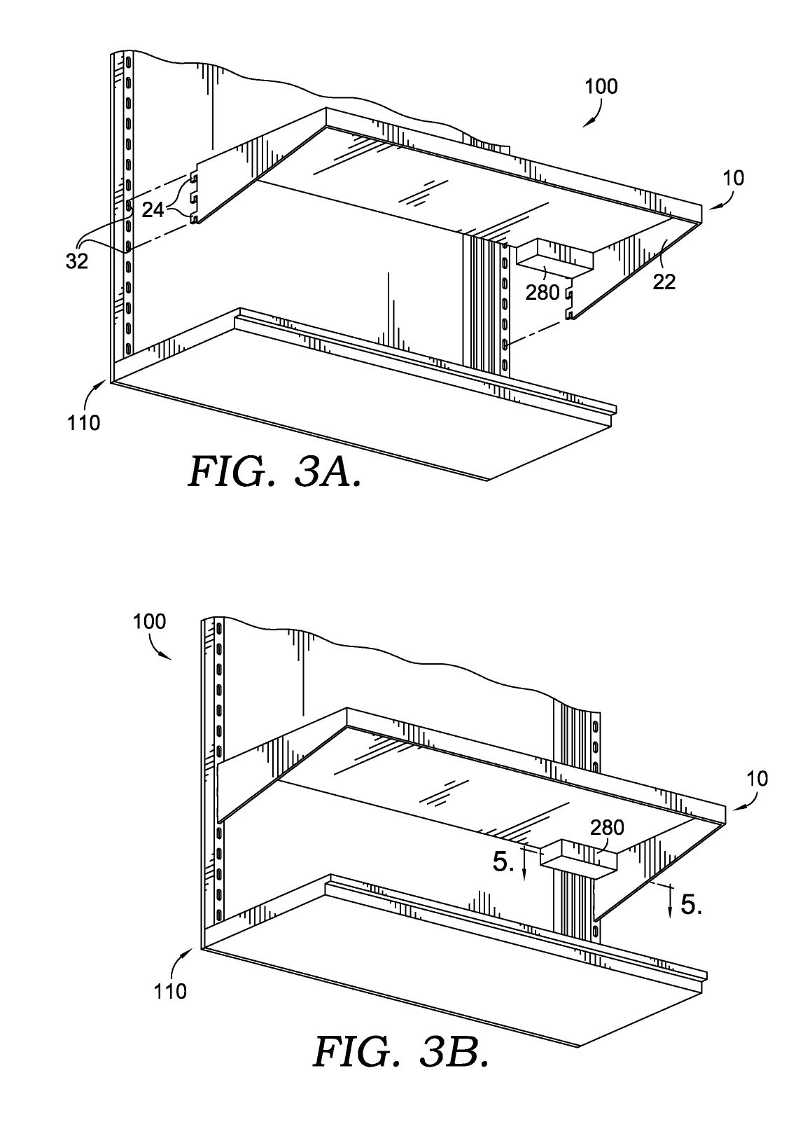

Turning now to FIGS. 3-5, the power-supply device 200 that provides power to shelf 10 further includes a power-receiving component 280 that is attachable to shelf 10. Shelf 10 is typically made of metal, but could be made of other materials as well. It is contemplated that shelf 10 could be any type of article supporting structure (e.g., counter, ledge, mantle, rack) that might be used to hold items that are being displayed, stored, or offered for sale. The power-receiving component 280 may be attached to the shelf 10 via an attachment mechanism. The attachment mechanism includes an adhesive, clasp, screw, and other suitable attachment mechanism as understood in the art. In one embodiment, the power-receiving component 280 is be attached to the bottom surface 20 proximate a back portion 14 of the shelf 10. Alternatively, the power-receiving component 280 might be mounted on any part of the shelf 10 that provides alignment with the power-conducting element 222 when the shelf 10 is mounted to the uprights 30.

As shown in FIGS. 4-5, in one embodiment the power-receiving component 280 includes a power-receiving element 282 adapted to engage the power-conducting element 222 to make an electrical connection. For example, the power-transmitting rail 220 might be attached to the shelving system 100 adjacent to the uprights 30. The power-transmitting rail 220 might be attached in a vertical orientation with reference to the uprights 30 of the shelving system 100. The proximity between the power-transmitting rail 220 and the uprights 30 and the brackets 24 engaging the slots 32 allow proper engagement to occur between the power-conducting element 222 and a power-receiving element 282. Attaching the brackets 24 of the shelf 10 at slots 32 aligns the power-conducting element 222 and the power-receiving element 282 to make contact. As should be appreciated, the brackets 24 and slots 32 serve as guides for placing the power-conducting element 222 and the power-receiving element 282 in correct engagement position. Alternatively, the power-receiving component 280 might engage the power-conducting element 222 via the power-conducting assembly 230 mounted at a particular point on the power-transmitting rail 220.

In embodiments, the power-receiving element 282 engages the power-conducting element 222 to make an electrical connection simultaneously as the brackets 24 and slots 32 are attached together. By way of example, the power-receiving element 282 might be spring-loaded contacts which is be used to provide electrical contact with the power-conducting element 222. The shelf 10 attaches in a detachable fashion to the slots 32 which in turn provide for electrical contact between the spring-loaded contacts and the power-conducting element 222. Spring-loaded contacts are provided with flexible electrical contact segments that resiliently press connection contacts against the power-conducting element 222 to prevent contact failure. In operation, the spring-loaded contacts retract as they are brought into engagement with the power-conducting element 222 while maintaining spring contact against the power-conducting element 222 for effective electrical contact.

As shown in FIG. 6B, the power-receiving component 280 transmits power to an electrical device 50 coupled to the power-receiving component 280 of the shelf 10. The power-receiving component 280 acts as a power source for the electrical device 50 on the shelf 10 in that it transmits power to the device. The electrical device 50 is coupled to the power-receiving component 280 such that power is transmitted to the device. The electrical device 50 might be a powered advertisement coupled to the power-receiving component 280 of the shelf 10. The electrical device 50 might also be an inductive transmitting coil integrated into the shelf 10 for inductively powering devices on the shelf 10. For example, inductive charging or wireless charging using an electromagnetic field to transfer energy.

Further, it is contemplated that the electrical device 50 might be coupled via an electrical connector at the power-receiving component 280. For example, the power-receiving component 280 might comprise a terminal block that provides a convenient means for connecting individual electrical connections from one or more electrical devices. The power-receiving component 280 might also comprise an electrical connector with power leads. The electrical device 50 might be directly attachable to the power lead for flexible connectivity. Other types of electrical connectors are contemplated within the scope of the present invention.

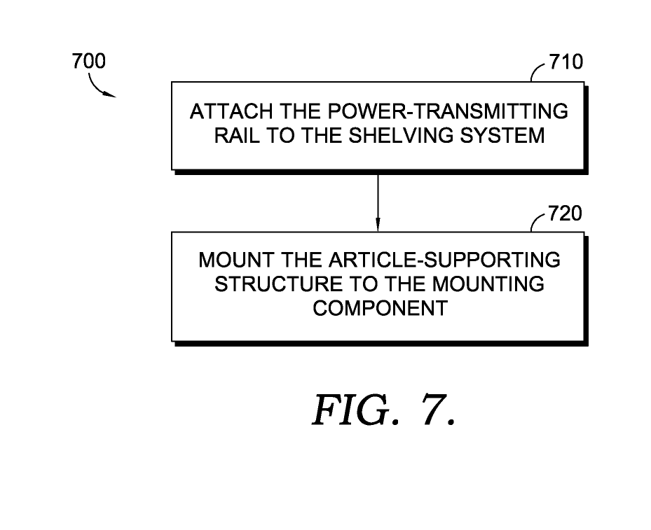

Turning to FIG. 7, a flow diagram 700 of an illustrative process for attaching a power-supply device 200 on a shelving system 100 to retrofit and provide power to the shelving system 100. The shelving system 100 includes a base structure. The shelving stem also has slots 32 or mounting components that receive a shelf 10 or article supporting component at various positions along a first orientation. The process 700 starts at step 710 where a power-transmitting rail 220 that includes a power-conducting element 222 encased in a protective cover is attached in a second orientation substantially similar to the first orientation and adjacent to the mounting component. The power-supply device 200 provides power to the shelving system 100 via the power transmitting rail 220 that includes one or more conductive rails (e.g., power-conducting element 222). Typically the power-transmitting rail 220 includes one or more voltage, neutral, and a grounding power-conducting element 222, or other suitable configurations as is understood in the art. The power-transmitting rail 220 might be attached to the shelving system 100 adjacent to the uprights 30. The proximity between the power-transmitting rail 220 and the uprights 30 and the brackets 24 engaging the slots 32 allow proper engagement to occur between the power-conducting element 222 and a power-receiving element 282. Attaching the brackets 24 of the shelf 10 aligns the power-conducting element 222 and the power-receiving element 282 to make contact. As should be appreciated, the brackets 24 and slots 32 serve as guides for placing the power-conducting element 222 and the power-receiving element 282 in correct engagement position.

At step 720, shelf 10 is mounted on the slots 32 to cause alignment and contact between a power-receiving element 282 of a power-receiving component 280 and the power-conducting element 222. The power-receiving component 280 is attached to the shelf 10 via an attachment mechanism. In one embodiment, the power-receiving component 280 is attached to the bottom surface 20 proximate a back portion 14 of the shelf 10. Alternatively, the power-receiving component 280 might be mounted on any part of the shelf 10 that provides alignment with the power-conducting element 222 when the shelf 10 is mounted to the upright 30. In embodiments, the power-receiving element 282 engages the power-conducting element 222 to make an electrical connection simultaneously as the brackets 24 and slots 32 are attached together. By way of example, the power-receiving element 282 are spring-loaded contacts which are be used to provide electrical contact with the power-conducting element 222. In operation, the spring-loaded contacts retract as they are brought into engagement with the power-conducting element 222 while maintaining spring contact against the power-conducting element 222 for effective electrical contact.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and might be employed without reference to other features and sub-combinations and are contemplated within the scope of the claims.

Claimed are:

1. A power-supply device that is attachable to a shelving system, which includes a base structure having a mounting component that receives an article-supporting structure at various positions along a first orientation, the power-supply device comprising:
a power-transmitting rail having a power-conducting element encased in a protective cover, wherein the power-transmitting rail is attachable to the shelving system in a second orientation substantially similar to the first orientation and adjacent to the mounting component; and
a power-receiving component having a power-receiving element adapted to engage the power-conducting element, wherein the power-receiving component is attachable to the article-supporting structure, and wherein the article-supporting structure aligns the power-receiving element to contact the power-conducting element when the article-supporting structure is attached to the mounting component of the shelving system.

2. The power-supply device of claim 1, wherein the power-conducting element conducts electricity throughout the power-conducting element extending a length of the power-transmitting rail.

3. The power-supply device of claim 1, wherein the power-transmitting rail further includes a power-conducting assembly that is attachable to the power-transmitting rail to conduct electrical power.

4. The power-supply device of claim 1, wherein the power-transmitting rail is adapted for snap-in engagement in a position adjacent to the mounting component.

5. The power-supply device of claim 1, wherein the power-receiving component is attachable to a bottom surface of the article-supporting structure and positioned proximate a back portion of the article-supporting structure.

6. The power-supply device of claim 1, wherein the power-receiving element is a spring-loaded contact.

7. A power-supply device that is attachable to a shelving system to retrofit, and provide power to, the shelving system, which includes a back panel supporting an upright mounting component that receives a shelf, the power-supply device comprising:
a power-transmitting rail having a power-conducting element encased in a protective cover, wherein the power-transmitting rail is attachable to the back panel adjacent to the upright mounting component that receives the shelf; and
a power-receiving component having a power-receiving element adapted to engage the power-conducting element, wherein the power-receiving component is attached to the shelf, and wherein the shelf aligns the power-receiving element to contact the power-conducting element when the shelf is attached to the upright mounting component of the shelving system.

8. The power-supply device of claim 7, wherein the upright mounting component comprises a slot and the shelf further comprises a bracket positioned proximate a back portion of the shelf, wherein the power-conducting element contact with the power-receiving element is simultaneously engaged when the bracket is mounted on the slot.

9. The power-supply device of claim 7, wherein the power-transmitting rail is adapted for snap-in engagement in a position adjacent the upright mounting component such that at least one side of power-transmitting rail is placed along an inner edge of the upright mounting component.

10. The power-supply device of claim 7, wherein the power-transmitting rail is coupled to a power-source rail, wherein the power-source rail is connected to a transformer to provide power to the power-transmitting rail.

11. The power-supply device of claim 10, wherein the power-transmitting rail is coupled to the power-source rail via a power-conducting assembly

12. The power-supply device of claim 10, wherein the transformer is attached to the shelving system and converts line AC voltage to low voltage DC to provide power to the power-source rail.

13. The power-supply device of claim 7, wherein the power-receiving component is attached to a bottom surface of the shelf and positioned proximate a back portion of the shelf.

14. The power-supply device of claim 7, wherein the power-receiving component transmits power to an electrical device coupled to the power-receiving component of the shelf.

15. The power-supply device of claim 14, wherein the electrical device is an inductive transmitting coil, a powered advertisement, or an electronic price display coupled to the power-receiving component of the shelf.

16. A method for retrofitting, and providing power to, a shelving system, which includes a base structure having a mounting component that receives an article-supporting structure at various positions along a first orientation, the method comprising:
attaching a power-transmitting rail having a power-conducting element encased in a protective cover to the base structure to the shelving system, wherein the power-transmitting rail is positioned in a second orientation substantially similar to the first orientation and adjacent to the mounting component; and
mounting the article-supporting structure to the mounting component to cause alignment and contact between a power-receiving element of a power-receiving component and the power-conducting element, wherein the power-receiving component is attachable to the article-supporting structure.

17. The method of claim 16, wherein the power-transmitting rail is adapted for snap-in engagement in a position adjacent to the mounting component.

18. The method of claim 16, further comprising:
connecting the power-transmitting rail to a power port attached to a power-source rail; and
coupling the power-source rail to a transformer to provide power to the power-transmitting rail.

19. The method of claim 16, wherein mounting article supporting structure to the mounting component simultaneously engages the contact between the power-conducting element and the power-receiving element.

20. The method of claim 16, wherein the power-receiving element is a spring-loaded contact.
